(19) United States
(12) Patent Application Publication
(10) Pub. No.: US 2026/0088272 A1
(43) Pub. Date: Mar. 26, 2026

(54) Systems and Methods for the Controlling the Temperature of Powder Hoppers

(71) Applicants: Matthews International GmbH, Vreden (DE); Matthews International Corporation, Pittsburgh, PA (US)

(72) Inventors: Thomas HACKFORT, Ahaus-Alstätte (DE); Harald BARTSCH, Dorsten (DE); Frank LAUKAMP, Gronau-Epe (DE); Benedikt IBING, Ahaus (DE)

(21) Appl. No.: 19/108,472

(22) PCT Filed: Sep. 5, 2023
(86) PCT No.: PCT/EP2023/074324

§ 371 Date: Mar. 4, 2025

Related U.S. Application Data
(60) Provisional application No. 63/403,990, filed on Sep. 6, 2022.

(51) Int. Cl. H01M 4/04; F25B 21/00; G05D 23/19; H05B 3/00; H05B 6/10

(52) U.S. Cl. CPC H01M 4/0435; G05D 23/19; F25B 21/00; H05B 3/0014; H05B 6/10

(57) ABSTRACT

The invention refers to systems and methods for controlling the temperature in powder hoppers to regulate the temperature of a dry electrode precursor material are described. For example, a system can include at least one powder hopper, at least one heating element, and at least one calender roller.

### BACKGROUND

In the field of forming products such as sheets, films, and webs, handling such products, calendering, and the like, there is frequently the need to produce these products precisely with minimal thickness variation. One method of maintaining the minimal thickness variation and achieving a uniform thermal expansion of the rollers used in the forming of the products is heating the roller to a uniform temperature. In cases where the rollers are heated, the heat is often emitted from the roller and absorbed by the surrounding environment, including powder hoppers used to provide the ingredients to form the products.

Furthermore, when forming components for electrochemical cells, capacitors, or supercapacitors, accurate temperature control of the ingredients is critical. The ingredients that form the electrodes of such electrochemical cells, capacitors, or super capacitors must be processed at the correct temperature and pressure in order to form electrode layers that meet stringent specifications for thickness and uniformity. The ingredients that form the electrodes often include binders that are sensitive to high temperatures that must be maintained at a temperature lower than the rollers to prevent activating the binder prematurely. Additionally, the ingredients that form the electrodes often require preheating before introducing the ingredients to the rollers.

There is a need for improvement in powder hoppers with respect to controlling the temperature of the powder hopper and the powder material held within the powder hopper.

### SUMMARY

In one embodiment, a system comprises: at least one powder hopper and at least one heating element; wherein the at least one heating element is configured to heat the powder hopper.

In one embodiment, a method of manufacturing an electrode film comprises: providing a dry electrode precursor material, at least one powder hopper, and at least one calender roller, wherein powder hopper includes at least one temperature control element, wherein the at least one temperature control elements are included of at least one heating element, at least one cooling element, or combinations thereof; and adjusting the temperature of the at least one powder hopper using the at least one temperature control elements; and supplying the dry electrode precursor material to the at least one powder hopper; and contacting the at least one calender roller with the dry electrode precursor material.

In one embodiment, a dry electrode is produced by: providing a dry electrode precursor material, at least one powder hopper, and at least one calender roller, wherein the powder hopper includes at least one temperature control elements; adjusting the temperature of the at least one powder hopper using the at least one temperature control elements; supplying the dry electrode precursor material to the at least one powder hopper; and contacting the calender roller with the dry electrode precursor material.

In one embodiment a method of manufacturing a powder hopper comprises: providing at least two powder hopper parts; providing at least one heating element; joining the at least one heating element and the at least two powder hopper parts; and joining the at least two powder hopper parts.

### DESCRIPTION OF DRAWINGS

Aspects, features, benefits and advantages of the embodiments described herein will be apparent with regard to the following description, appended claims, and accompanying drawings where:

FIG. 1 depicts an illustrative system having a temperature-controlled powder hopper in accordance with an embodiment.

FIG. 2 depicts an illustrative system having a temperature-controlled powder hopper in accordance with an embodiment.

FIG. 3 depicts an illustrative system having a temperature-controlled powder hopper in accordance with an embodiment.

FIG. 4 depicts a diagram of a method of manufacturing an electrode in accordance with an embodiment.

### DEFINITIONS

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

### DETAILED DESCRIPTION

This disclosure is not limited to the particular systems, devices and methods described, as these may vary. The terminology used in the description is for the purpose of describing the particular versions or embodiments only and is not intended to limit the scope.

### Systems

Systems can be assembled to aid in the temperature control of powder hoppers. In some embodiments, the system comprises at least one powder hopper and at least one heating element configured figured to heat the powder hopper. In some embodiments, the system further comprises at least one heating element configured to cool the powder hopper. In some embodiments, the system further comprises at least one insulation layer configured to retain heat within the powder hopper and to prevent heat from the surrounding environment from entering the roller. In some embodiments, the system further comprises at least one calender roller. In some embodiments, the system is a calendering line. In some embodiments, the powder hopper can further comprise at least one powder material such as a dry electrode powder precursor or other powder materials. The powder hopper can further comprise one powder material or a mixture of two or more powder materials such as two, three, four, five, six, or more different powder materials.

Use of the described methods and materials can result in a regulation of the temperature of dry electrode precursor powder to a desired temperature than without the described methods and materials. The temperature of the dry electrode powder precursor can generally be regulated to a range of the desired temperature. For example, the temperature of the dry electrode powder precursor can generally be regulated to a desired temperature with a tolerance of about 5° C., about 4° C., about 3° C., about 2° C., about 1° C., and, in an ideal situation, about 0° C.

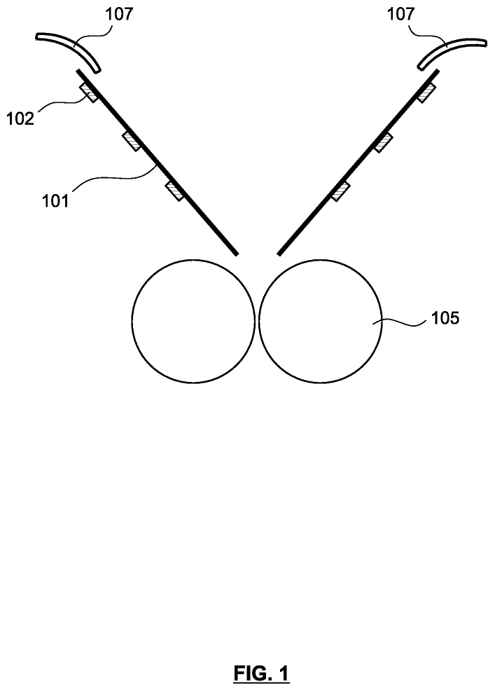

FIG. 1 illustrates a system with at least one powder hopper 101 and at least one heating element 102 configured to heat the at least one powder hopper 101. In some embodiments, the at least one powder hopper 101 comprises an inner surface and an outer surface, and the inner surface is configured to receive a dry electrode precursor material. In some embodiments, the at least one heating element 102 is positioned on the outer surface of the at least one powder hopper 101. In some embodiments, the system further comprises at least one calender roller 105, and the calender roller is configured to receive the dry electrode material from the at least one powder hopper 101.

The at least one heating element 102 can generally be any heating element effective to heat at least one powder hopper 101 known to one of skill in the art. For example, the at least one heating element 102 can comprise at least one fluid heating channel, at least one resistive heating element, at least one inductive heating element, or combinations thereof. In some embodiments, the least one heating element 102 is configured to cover the entire outer surface of the at least one powder hopper 101. In some embodiments, the at least one heating element 102 is configured to cover a portion of the entire outer surface of the at least one powder hopper 101. A gas dispensing device 107 can be provided at the powder hopper 101 for flushing the hopper 101 with dry gas for preventing condensation.

In some embodiments, the at least one heating element 102 is configured to heat the at least one powder hopper 101 to a known temperature and maintain the temperature of the at least one powder hopper 101 at the known temperature, wherein the known temperature corresponds to a known temperature of the dry electrode precursor material. In some embodiments, the at least one heating element 102 is configured to maintain the at least one powder hopper 101 at a temperature in a range of between 0° C. to 350° C., such as about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., about 300° C., about 325° C., about 350° C., or any value or range of values between any two of these values.

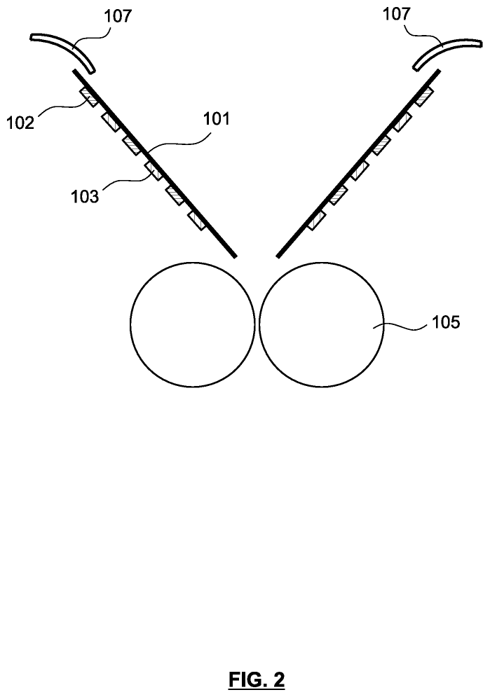

FIG. 2 illustrates a system with at least one powder hopper 101 and at least one heating element 102 configured to heat the at least one powder hopper 101. In some embodiments, the at least one powder hopper 101 comprises an inner surface and an outer surface, and the inner surface is configured to receive a dry electrode precursor material. In some embodiments, the at least one heating element 102 is positioned on the outer surface of the at least one powder hopper 101. In some embodiments, the system further comprises at least one cooling element 103 configured to cool the at least one powder hopper 101. In some embodiments, the system further comprises at least one calender roller 105, and the calender roller is configured to receive the dry electrode material from the at least one powder hopper 101.

The at least one cooling element 103 can generally be any cooling element effective to cool at least one powder hopper 101 known to one of skill in the art. For example, the at least one cooling element 103 can comprise at least one fluid cooling channel, at least one thermoelectric cooler, or combinations thereof. In some embodiments, the least one at least one cooling element 103 is configured to cover the entire outer surface of the at least one powder hopper 101. In some embodiments, the at least one heating element 102 is configured to cover a portion of the entire outer surface of the at least one powder hopper 101. A gas dispensing device 107 can be provided at the powder hopper 101 for flushing the hopper 101 with dry gas for preventing condensation.

In some embodiments, the at least one cooling element 103 is configured to cool the at least one powder hopper 101 to a known temperature and maintain the temperature of the at least one powder hopper 101 at the known temperature, wherein the known temperature corresponds to a known temperature of the dry electrode precursor material. In some embodiments, the at least one cooling element 103 is configured to maintain the at least one powder hopper 101 at a temperature of about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about no ° C., about 115° C., about 120° C., about 125° C., about 130° C., about 135° C., about 140° C., about 145° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., about 300° C., about 325° C., about 350° C., or any value or range of values between any two of these values.

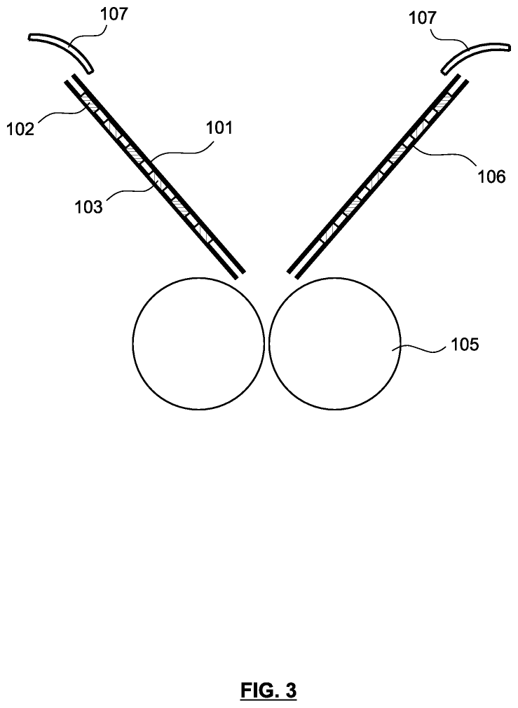

FIG. 3 illustrates a system with at least one powder hopper 101 and at least one heating element 102 configured to heat the at least one powder hopper 101. In some embodiments, the at least one powder hopper 101 comprises an inner surface and an outer surface, and the inner surface is configured to receive a dry electrode precursor material. In some embodiments, the at least one heating element 102 is positioned on the outer surface of the at least one powder hopper 101. In some embodiments, the system further comprises at least one cooling element 103 configured to cool the at least one powder hopper 101. In some embodiments, the system further comprises at least one calender roller 105, and the calender roller is configured to receive the dry electrode material from the at least one powder hopper 101. In some embodiments, the system further comprises at least one insulation layer 106.

In some embodiments, the at least one insulation layer 106 is positioned on the outside surface of the at least one powder hopper 101. In some embodiments, the at least one insulation layer 106 is configured to cover the entire outer surface of the at least one powder hopper 101. In some embodiments, the at least one insulation layer 106 is configured to cover a portion of the entire outer surface of the at least one powder hopper 101. In some embodiments, the at least one heating element 102 is positioned between the at least one powder hopper 101 and the at least one insulation layer 106. In some embodiments, the at least one cooling element 103 is positioned between the at least one powder hopper 101 and the at least one insulation layer 106.

In some embodiments, the at least one insulation layer 106 is configured to retain heat within the at least one powder hopper 101. Retaining heat within the at least one powder hopper 101 allows for a more accurate control of the temperature of the at least one powder hopper 101 and limits the heat from within the at least one powder hopper 101 from entering the surrounding environment. In some embodiments, the at least one insulation layer 106 is configured to prevent heat from the environment surrounding the at least one powder hopper 101 from entering the at least one powder hopper 101. A gas dispensing device 107 can be provided at the powder hopper 101 for flushing the hopper 101 with dry gas for preventing condensation.

The at least one insulation layer 106 can be comprised of any material effective as a thermal insulator known to one of skill in the art. For example, the at least one insulation layer 106 can be comprised of carbon fiber, ceramic fiber, fiberglass, mineral wool, PTFE, PEEK, nylon, polypropylene, vacuum insulation panels, or combinations thereof. In some embodiments, the at least one insulation layer 106 has a thickness of about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 25 mm, about 30 mm, or any value or range of values between these values.

In some embodiments, the system further comprises at least one temperature sensor configured to measure the temperature of the at least one powder hopper. In some embodiments, the at least one temperature sensor is positioned inside the at least one powder hopper. In some embodiments, the at least one temperature sensor is positioned outside the at least one powder hopper. In some embodiments, the system further comprises at least one processing device. In some embodiments, the at least one temperature sensor is configured to transmit temperature measurements to the at least one processing device. Each of the at least one temperature sensor can be configured to transmit temperature measurements to a display device by a wired or a wireless connection, such as through a network, WiFi, or Bluetooth connection.

### Methods of Use

Methods can be performed to manufacture an electrode film using the above-described systems for controlling the temperature of a powder hopper.

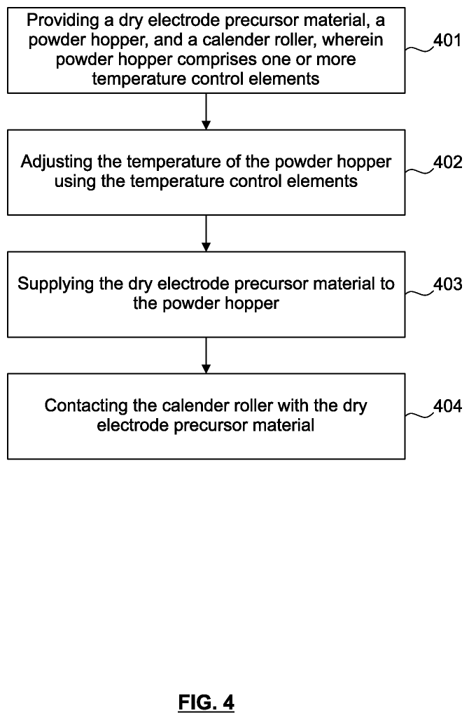

FIG. 4 illustrates a diagram for manufacturing an electrode film. The method comprises providing 401 a dry electrode precursor material, at least one powder hopper, and at least one calender roller, wherein the powder hopper comprises at least one temperature control element. The method further comprises adjusting 402 the temperature of the at least one powder hopper using the at least one temperature control elements, supplying 403 the dry electrode precursor material to the at least one powder hopper; and contacting 404 the at least one calender roller with the dry electrode precursor material.

In some embodiments, the at least one temperature control element comprises at least one heating element and adjusting 402 the temperature of the at least one powder hopper comprises heating the powder hopper. In some embodiments, the at least one heating element can heat the at least one powder hopper by any method known to one of skill in the art. For example, the at least one heating element can heat the at least one powder hopper by passing a using fluid through a fluid heating channel, by using a resistive heating element, by heating an inductive heating element, or combinations thereof.

In some embodiments, the at least one temperature control element comprises at least one cooling element and adjusting 402 the temperature of the at least one powder hopper comprises cooling the powder hopper. In some embodiments, the at least one cooling element can heat the at least one powder hopper by any method known to one of skill in the art. For example, the at least one cooling element can cool the at least one powder hopper by passing a cooling fluid through a fluid cooling channel, by using a thermoelectric cooler, or combinations thereof.

The temperature of the powder hopper can generally be adjusted 402 to any temperature known to one of skill in the art. In some embodiments, the temperature of the powder hopper is maintained at a level in a range of between 0° C. and 350° C., such as about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., about 300° C., about 325° C., about 350° C., or any value or range of values between any two of these values. In some embodiments, the temperature of the powder hopper is maintained at about 20° C. to about 350° C., about 20° C. to about 200° C., about 20° C. to about 40° C., about 60° C. to about 150° C., about 90° C. to about 120° C., or any value or range of values between any two of these values.

### Methods of Manufacture

Methods can be assembled to manufacture a powder hopper comprising at least one heating element. The method comprises providing at least two powder hopper parts, providing at least one temperature control element, joining the at least one temperature control element and the at least two powder hopper parts, and joining the at least two powder hopper parts. The at least two powder hopper parts can be manufactured by any manufacturing process known to one of skill in the art. In some embodiments, the at least two powder hopper parts are manufactured using CNC machining, forging, investment casting, injection molding, pressure die casting, additive manufacturing, or combinations thereof.

In some embodiments, the at least one temperature control element comprises at least one heating element. In some embodiments, the at least one heating element can be manufactured by any manufacturing process known to one of skill in the art. In some embodiments, the at least one heating element is manufactured by mechanical alloying, combustion synthesis, shock synthesis, hot isostatic pressing, gas metal arc welding, are welding, tungsten inert gas welding, flux core arc welding, sputtering deposition, extrusion, CNC machining, forging, investment casting, injection molding, pressure die casting, additive manufacturing, or combinations thereof.

In some embodiments, the at least one temperature control element comprises at least one cooling element. In some embodiments, the at least one cooling element can be manufactured by any manufacturing process known to one of skill in the art. In some embodiments, the at least one cooling elements is manufactured by mechanical alloying, gas metal arc welding, arc welding, tungsten inert gas welding, flux core arc welding, directional crystallization, pressed powder metallurgy, extrusion, CNC machining, forging, investment casting, injection molding, pressure die casting, additive manufacturing, or combinations thereof.

At least one temperature control element can be joined to the at least two powder roller parts by any method known to one of skill in the art. For example, the at least one temperature control element and the at least two powder hopper parts can be joined by gas metal arc welding, are welding, tungsten inert gas welding, flux core arc welding, soldering, blending, adhesive bonding, mechanical fastening, or combinations thereof.

In some embodiments, the at least two powder hopper parts can be joined by any process effective to combine metallic parts to one of skill on the art. For example, the at least two powder hopper parts can be joined by gas metal arc welding, are welding, tungsten inert gas welding, flux core arc welding, soldering, blending, adhesive bonding, mechanical fastening, or combinations thereof.

In some embodiments, the method further comprises manufacturing at least one insulation layer. The at least one insulation layer can be manufactured by any manufacturing process known to one of skill in the art. In some embodiments, the at least one insulation layer is manufactured by transfer molding, injection molding, melt molding, compression molding, vacuum forming, pultrusion, or combinations thereof. In some embodiments, the at least one insulation layer is joined with the at least two powder hopper parts. The at least one insulation layer can be joined with the at least two powder hopper parts by any method known to one of skill in the art. For example, the at least one insulation layer can be joined with the at least two powder hopper parts by adhesive bonding, mechanical fastening, or combinations thereof.

Various of the above-disclosed and other features and functions, or alternatives thereof, may be combined into many other different systems, methods or applications. Various presently unforeseen or unanticipated alternatives, modifications, variations or improvements therein may be subsequently made by those skilled in the art, each of which is also intended to be encompassed by the disclosed embodiments.

1. A system comprising at least one powder hopper and at least one cooling and/or heating element, wherein the at least one cooling and/or heating element is configured to cool and/or heat the powder hopper.

2. The system of claim 1, wherein each of the at least one heating element is comprised of at least one fluid cooling and/or heating channels, at least one inductive heating element, at least one resistive heating element, or combinations thereof.

3. The system of claim 1, further comprising at least one cooling element configured to cool the powder hopper, wherein the at least one cooling element is comprised of at least one fluid cooling channel, at least one thermoelectric cooler, or combinations thereof.

4. The system of claim 1, further comprising at least one insulating layer, wherein:
each of the at least one insulation layers are positioned on the surface of the at least one powder hopper.

5. The system of claim 4, wherein each of the at least one insulation layers are comprised of fiberglass, mineral wool, PTFE, PEEK, nylon, polypropylene, vacuum insulation panels, or combinations thereof.

6. The system of claim 1, further comprising at least one temperature sensor and at least one processing device, wherein:
the at least one temperature sensor is positioned inside the at least one powder hopper; and,
the at least one temperature sensor is configured to transmit temperature measurements to the at least one processing device.

7. The system of claim 1, further comprising at least one temperature sensor and at least one processing device, wherein:
the at least one temperature sensor is positioned outside the at least one powder hopper; and
the at least one temperature sensor is configured to transmit temperature measurements to the at least one processing device.

8. The system of claim 1, further comprising a gas dispensing device configured for flushing the powder hopper with dry gas to prevent condensation.

9. A method of manufacturing an electrode film, the method comprising:
providing a dry electrode precursor material, at least one powder hopper, and at least one calender roller, wherein the powder hopper comprises at least one temperature control element, wherein the at least one temperature control elements are comprised of at least one heating element at least one cooling element, or combinations thereof;
adjusting the temperature of the at least one powder hopper using the at least one temperature control element;
supplying the dry electrode precursor material to the at least one powder hopper; and
contacting the at least one calender roller with the dry electrode precursor material.

10. The method of claim 9, wherein the at least one powder hopper is maintained at a temperature of about 0° C. to about 350° C.

11. The method of claim 9, wherein the at least one powder hopper is maintained at a temperature of about 20° C. to about 300° C.

12. The method of claim 9, wherein the at least one powder hopper is maintained at a temperature of about 40° C. to about 200° C.

13. The method of claim 9, wherein the at least one powder hopper is maintained at a temperature of about 60° C. to about 150° C.

14. The method of claim 9, wherein the at least one powder hopper is maintained at a temperature of about 90° C. to about 120° C.

15. A dry electrode, wherein the dry electrode is manufactured by:
providing a dry electrode precursor material, at least one powder hopper, and at least one calender roller, wherein the powder hopper comprises at least one temperature control element;
adjusting the temperature of the at least one powder hopper using the at least one temperature control element;
supplying the dry electrode precursor material to the at least one powder hopper; and
contacting the calender roller with the dry electrode precursor material.

16. A method of manufacturing a powder hopper, the method comprising: providing at least two powder hopper parts;
providing at least one cooling and/or heating element;
joining the at least one cooling and/or heating element and the at least two powder hopper parts; and
joining the at least two powder hopper parts.

17. The method of claim 16, wherein the at least two powder hopper parts are manufactured by CNC machining, forging, investment casting, injection molding, pressure die casting, additive manufacturing, or combinations thereof.

18. The method of claim 16, wherein the at least one cooling and/or heating element is manufactured by mechanical alloying, combustion synthesis, shock synthesis, hot isostatic pressing, gas metal arc welding, arc welding, tungsten inert gas welding, flux core arc welding, sputtering deposition, extrusion, CNC machining, forging, investment casting, injection molding, pressure die casting, additive manufacturing, directional crystallization, pressed powder metallurgy, or combinations thereof.

19. The method of claim 16, wherein the at least one cooing and/or heating element is joined to the at least two powder hopper parts by gas metal arc welding, arc welding, tungsten inert gas welding, flux core arc welding, soldering, blending, adhesive bonding, mechanical fastening, or combinations thereof.

20. The method of claim 16, wherein the at least two powder hopper parts are joined by gas metal arc welding, arc welding, tungsten inert gas welding, flux core arc welding, soldering, blending, adhesive bonding, mechanical fastening, or combinations thereof.

21. The method of claim 16, further comprising:
providing at least one cooling element and at least one heating element; and
joining the at least one cooling elements and at least one heating element with the at least two powder hopper parts.

22. The method of claim 16, further comprising flushing the powder hopper with dry gas to prevent condensation.
